(19) United States
(12) Patent Application Publication
(10) Pub. No.: US 2025/0144911 A1
(43) Pub. Date: May 8, 2025

(54) HIGH-DURABILITY DUAL COMPOSITE WATERPROOF STRUCTURE THROUGH INORGANIC ELASTIC UNDERCOAT BODY AND COMPOSITE SHEET WATERPROOF STRUCTURE WITH HEAT SHIELDING AND HEAT DISSIPATION PERFORMANCE

(71) Applicant: DEFINITE WATERTIGHTNESS CO.,LTD, Seoul (KR)

(72) Inventor: Jong Gug KIM, Seoul (KR)

(73) Assignee: DEFINITE WATERTIGHTNESS CO.,LTD, Seoul (KR)

(21) Appl. No.: 18/838,228

(22) PCT Filed: Oct. 13, 2022
(86) PCT No.: PCT/KR2022/015479

§ 371 Date: Aug. 13, 2024

(30) Foreign Application Priority Data
Feb. 17, 2022 (KR) 10-2022-0020731

(51) Int. Cl. B32B 5/26; B32B 5/02; C04B 14/06; C04B 14/10; C04B 16/06; C04B 18/14; C04B 18/24; C04B 24/26; C04B 24/42; C04B 28/14; C04B 41/45; C04B 41/48; C04B 41/52; C04B 41/71; C04B 103/12; C04B 103/22; C04B 103/42; C04B 103/60; C04B 111/27

(52) U.S. Cl. CPC B32B 5/26; B32B 5/02; C04B 14/062; C04B 14/106; C04B 16/0691; C04B 18/146; C04B 18/24; C04B 24/2635; C04B 24/42; C04B 28/14; C04B 41/4539; C04B 41/4596; C04B 41/483; C04B 41/52; C04B 41/71; B32B 2255/02; B32B 2255/20; B32B 2255/26; B32B 2260/023; B32B 2260/046; B32B 2307/7265; C04B 2103/12; C04B 2103/22; C04B 2103/42; C04B 2103/601; C04B 2111/27

(57) ABSTRACT

Disclosed is a composite waterproof structure comprising: an inorganic elastic undercoat layer including an inorganic material on a construction surface; a complementary reinforced fiber or chopped fiber layer in the form of a mesh in the middle of an inorganic undercoat body; a first intermediate coat layer disposed on the inorganic elastic undercoat layer; a mesh-type fiber-reinforcing sheet layer attached onto the first intermediate coat layer; first and second impregnated layers provided on the mesh-type fiber-reinforcing sheet layer; a second intermediate coat layer disposed on the first and second impregnated layers; a third intermediate coat layer provided on the second intermediate coat layer; and a first top coat layer.

### DESCRIPTION

### Technical Field

The present invention relates to a dual composite waterproof structure to which an inorganic elastic undercoat body and an energy saving technology are added.

### Background Art

There is a composite waterproofing method in which, after an inorganic elastomer with waterproofing performance is applied in the form of plaster to reinforce cracks and the strength of low-density surfaces of a structure, a high elasticity and high durability acrylic resin is impregnated into a fiber reinforced sheet to form a multi-layer structure, thereby securing excellent durability, crack repairability, water resistance, and air permeability.

Inorganic materials such as building concrete or mortar have a problem in that moisture easily permeates and passes therethrough due to the nature of materials. This problem causes water leakage due to cracks caused by daily temperature differences, seasonal climate differences, vibrations, or the like and causes aging due to atmospheric pollutants, oxides, or the like.

In order to solve these crack and aging problems and maintain a comfortable indoor environment, generally, a waterproof layer is applied on a roof of a building. Methods of applying such a waterproof layer include a coating waterproofing method using a coating waterproofing agent, a sheet waterproofing method using a waterproofing sheet, and a composite coating waterproofing method using both a coating waterproofing agent and a waterproofing sheet.

Among these, a waterproof layer applied through a composite coating waterproofing method may have excellent waterproofing properties, but in particular, cracks in a concrete structure may be vulnerable over the long term. In order to solve such a problem, there is provided a dual composite waterproofing method in which, after an inorganic elastic undercoat body is used to reinforce a primary waterproof layer and the internal strength of a concrete material, which may be weak, the primary waterproof layer and the internal strength are reinforced with an eco-friendly acrylic waterproofing liquid and a special net sheet with enhanced tensile strength as compared to general non-woven fabrics to increase waterproofing performance and durability to have semi-permanent waterproofing performance, and which prevents global warming and adopts energy-saving technology by additionally finishing a multi-layer structure through heat shielding and heat dissipation painting using a heat barrier material.

As a result, the dual composite waterproofing method is an eco-friendly heat shielding composite waterproof structure method which provides excellent resistance to cracks in concrete structures, greatly reinforces the density and strength of concrete, and provides excellent waterproofing properties, tensile strength, mechanical and chemical properties, and air permeability.

### DISCLOSURE

### Technical Problem

The present invention is directed to providing a dual composite waterproof structure which has excellent waterproofing properties, excellent tensile strength, excellent heat shielding properties, and excellent mechanical and chemical properties, in which an inorganic elastic undercoat body is used to further improve the durability of a waterproof layer by compensating for the occurrence of cracks in an inorganic concrete slab, and which has excellent air permeability and waterproofing performance.

Meanwhile, the technical objects to be achieved in the present invention are not limited to the technical object described above, and other technical objects which are not described may be clearly understood to those skilled in the art from the following description.

### Technical Solution

A composite waterproof structure according to an embodiment of the present invention includes an inorganic elastic undercoat layer which includes an inorganic material and is disposed on a construction surface, a mesh-type fiber or chopped fiber reinforced layer attached to the elastic undercoat layer, a first intermediate coat layer disposed on the fiber reinforced layer, a fiber reinforced sheet layer attached to the first intermediate coat layer, a first impregnated layer and a second impregnated layer disposed on the fiber reinforced sheet layer, a second intermediate coat layer and a third intermediate coat layer disposed on the first and second impregnated layers, and a first top coat layer disposed on the second and third intermediate coat layers.

In addition, the elastic undercoat layer may be made of an elastic inorganic material and may include a raw material including heat shielding and heat radiation components in consideration of the special characteristics of a construction site.

A major component of the elastic undercoat layer is a liquid composition including 1 wt % to 10 wt % calcium sulfoaluminate (3Ca·3Al₂O₃·CaSO₄), which has a high fineness of 6,000 cm²/g to 12,000 cm²/g, 1 wt % to 10 wt % anhydrous gypsum, 20 wt % to 50 wt % of an inorganic binder in the form of an ultrafine powder, which is obtained by pulverizing portland cement type I to a fineness of 6,000 cm²/g to 9,000 cm²/g to have an average particle diameter of 4 μm, 5% to 10% of 325 mesh metakaolin, 40 wt % to 60 wt % of 0.5 mm to 2 mm silica sand, 5% to 10% silica fume, 1 wt % to 10 wt % ethylene vinyl acetate (EVA) powder resin, 0.1 wt % to 5 wt of 6 mm aramid fiber or nylon fiber with respect to 100 parts by weight, 0.1% to 5% of 40 μm to 50 μm cellulose fiber, 0.1 to 1 part by weight of a powdered silicone foaming agent including 0.1 to 2.0 parts by weight of an accelerator and 0.01 to 1 part by weight of a setting retarder, wherein the accelerator includes at least one or a mixture of one or more selected from sodium sulfide (Na₂S·9H₂O), sodium carbonate (Na₂Co₃), lithium carbonate (Li₂Co₃), and lithium hydroxide (LiOH·H₂O), and the setting retarder includes at least one or a mixture of one or more selected from citric acid, tartaric acid, gluconic acid, boric acid, and potassium carbonate, 1% to 5% of at least one anti-freezing and moisture-retaining agent selected from the group consisting of 10% to 30% aqueous acrylic emulsion resin with a glass temperature (Tg) of −35° C., 1% to 10% silicone resin, ethylene glycol, and propylene glycol, and 0.1% to 3% dispersant.

In addition, the elastic undercoat layer may include glass fibers, nonwoven fibers, net fibers, elastic fibers, or the like.

In addition, the composite waterproof structure may further include an elastic sheet layer disposed on a connection portion of the fiber reinforced sheet layer adjacent thereto.

In addition, the first intermediate coat layer may be disposed on the fiber reinforced sheet layer and the elastic sheet layer.

In addition, the first intermediate coat layer may include an acrylic emulsion resin.

### Advantageous Effects

According to embodiments of the present invention, it is possible to provide excellent waterproofing properties, excellent tensile strength, excellent heat blocking properties, excellent mechanical and chemical properties, and excellent air permeability.

Meanwhile, the effects to be achieved in the present invention are not limited to the effects, and other effects which are not described may be clearly understood to those skilled in the art from the following description.

### DESCRIPTION OF DRAWINGS

FIG. 1 is an exemplary view illustrating a composite waterproof structure according to one embodiment of the present invention.

FIG. 2 is an exemplary view for describing a reinforcing structure between sheet layers according to one embodiment of the present invention.

### MODES OF THE INVENTION

Hereinafter, embodiments of the present invention will be described in more detail with reference to the attached drawings. The embodiments of the present invention may be modified into various forms, and the scope of the present invention should not be construed as being limited to the following embodiments. The present embodiments are provided for more completely describing the present invention to those skilled in the art. Accordingly, the shapes of elements in the drawings may be exaggerated to emphasize a clearer description.

The configuration of the present invention for clarifying the solution to the problem to be solved by the present invention will be described in detail with reference to the accompanying drawings based on an exemplary embodiment of the present invention. In assigning reference numerals to components in the drawings, the same reference numerals are assigned to the same components even when they are on different drawings. Further, it should be noted in advance that components of other drawings may be cited when necessary when describing the drawing.

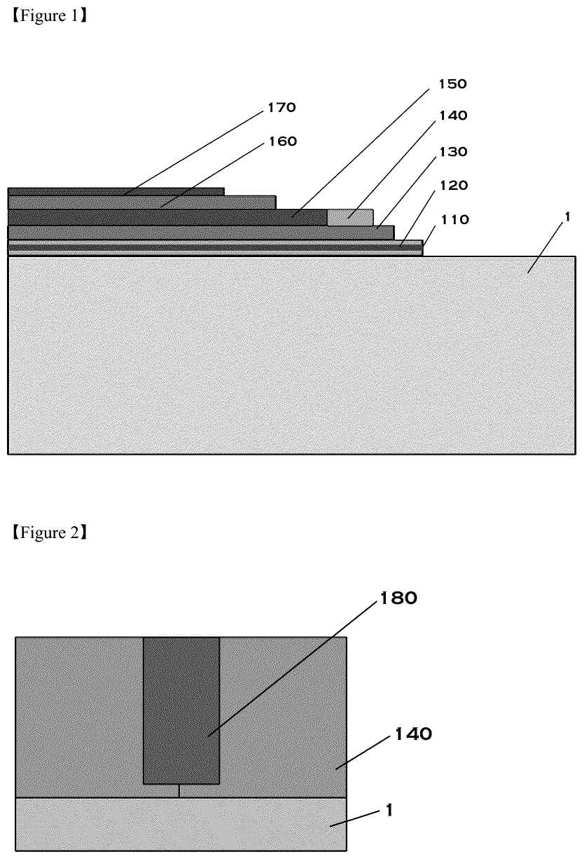

FIG. 1 is an exemplary view illustrating a dual composite waterproof structure using an inorganic waterproof elastic undercoat body according to one embodiment of the present invention.

Referring to FIG. 1, a composite waterproof structure 100 according to one embodiment of the present invention may include an elastic undercoat layer 110, a fiber reinforced layer 120, a first intermediate coat layer 130, a fiber reinforced sheet layer 140, first and second impregnated layers 150, second and third intermediate coat layers 160, and a first top coat layer 170.

Here, the composite waterproof structure 100 is installed on a construction surface 1 and includes the elastic undercoat layer 110, the inorganic fiber reinforced sheet layer 120, the first intermediate coat layer 130, the fiber reinforced sheet layer 140, the first and second impregnated layers 150, the second and third intermediate coat layers 160, and the first top coat layer 170 which are sequentially applied on the construction surface 1.

Here, the construction surface 1 may be a wall, a floor, or the like of a building. A preliminary process of cleaning a base surface and performing high-pressure washing may be performed on the construction surface 1. However, the present invention is not limited thereto.

The elastic undercoat layer 110 may be a layer for increasing the strength of the construction surface itself and reinforcing strength, may have the characteristics of reinforcing surface, enhancing waterproofing performance, reinforcing cracks, and increasing adhesion by including an elastic inorganic material and a fiber sheet capable of effectively increasing strength, and may be formed by being applied using a lacquer, a trowel, an automatic coating device, a roller, and the like.

The elastic undercoat layer 110 may include an inorganic filler, an acrylic resin, a curing agent, an accelerator, water, a hydrating agent, and the like.

The elastic undercoat layer 110 may include 1 wt % to 10 wt % calcium sulfoaluminate (3Ca·3Al₂O₃·CaSO₄), which has a high fineness of 6,000 cm²/g to 12,000 cm²/g, 1 wt % to 10 wt % anhydrous gypsum, 20 wt % to 50 wt % of an inorganic binder in the form of an ultrafine powder, which is obtained by pulverizing portland cement type I to a fineness of 6,000 cm²/g to 9,000 cm²/g to have an average particle diameter of 4 μm, 5% to 10% of 325 mesh metakaolin, 40 wt % to 60 wt % of 0.5 mm to 2 mm silica sand, 5% to 10% silica fume, 1 wt % to 10 wt % ethylene vinyl acetate (EVA) powder resin, 0.1 wt % to 5 wt % of 6 mm aramid fiber or nylon fiber with respect to 100 parts by weight, 0.1% to 5% of 40 μm to 50 μm cellulose fiber, 0.1 to 1 part by weight of a powdered silicone foaming agent including 0.1 to 2.0 parts by weight of an accelerator and 0.01 to 1 part by weight of a setting retarder, wherein the accelerator includes at least one or a mixture of one or more selected from sodium sulfide (Na₂S·9H₂O), sodium carbonate (Na₂Co₃), lithium carbonate (Li₂Co₃), and lithium hydroxide (LiOH·H₂O), and the setting retarder includes at least one or a mixture of one or more selected from citric acid, tartaric acid, gluconic acid, boric acid, and potassium carbonate,

1% to 5% of at least one anti-freezing and moisture-retaining agent selected from the group consisting of 10% to 30% aqueous acrylic emulsion resin with a glass temperature (Tg) of −35° C., 1% to 10% silicone resin, ethylene glycol, and propylene glycol, and 0.1% to 3% dispersant.

Among the components included in the elastic undercoat layer 110, the metakaolin and the silica fume are highly fine powder pozzolanic products, increase strength, prevent cracks in mortar, which may generated due to an alkali-aggregate reaction, and increase waterproofing power by blocking voids between silica sand and foam glass. The reason why metakaolin and silica fume are used together is that when metakaolin and silica fume are used together, short-term strength and long-term strength further increase and viscosity increases, which increases adhesion/adhesive strength between a sheet and top coat and undercoat.

When an EVA powder resin and an acrylic liquid resin are used separately, and only a liquid resin is used, material separation may occur, which may decrease surface strength, and when only a powder resin is used, the powder resin is not well dispersed or dissolved in water, which may degrade adhesion and waterproofing power. An EVA powder resin has higher adhesion than an acrylic resin, but has lower water resistance than the acrylic resin and thus is supplemented by mixing with the acrylic resin.

In addition, among the included components, the silicone resin increases waterproofing power and prevents water from leaking through water repellency when microcracks occur. 6 mm aramid or nylon fibers and micro-cellulose fibers are mixed and used to prevent cracks in a waterproof powder and increase impact strength, thereby withstanding external vibrations and impacts well. When only long fibers are added, productivity is low, and workability in the field is also lowered, and when only micro-fibers are added, crack and impact strength may not be satisfied. In addition, when micro-cellulose fibers were added in a certain amount or more, specific gravity was lowered, thereby maximizing an insulation effect.

The elastic undercoat layer may further include reinforcing mesh fibers.

The fiber reinforced layer 120 may be attached to the elastic undercoat layer 110 described above.

Meanwhile, the fiber reinforced layer 120 may be replaced with a mesh-type mesh sheet or chopped fiber that has excellent tensile strength, tearing strength, and paint impregnation characteristics per unit weight as compared to existing long fiber and short fiber sheets, thereby shortening an impregnation process.

in this case, the fiber reinforced layer 120 may have a width of 100 mm to 2,000 mm, a thickness of 0.35 mm to 2.0 mm, and a mass of 35 g/m² to 300 g/m². When an impact such as an earthquake or the like is applied to a structure to which a waterproof structure is applied, the occurrence of cracks may be suppressed by the fiber reinforced sheet layer 120, thereby preventing the sudden collapse of the structure and obtaining effects of improving crack resistance, impact resistance, weatherability, durability, waterproofing performance, insulation, and heat shielding performance.

As an example, a process of attaching a fiber reinforced layer 120 made of polyamide (PA) net fibers to a surface on which the elastic undercoat layer 110 is applied may be performed simultaneously as a continuous process.

The first intermediate coat layer 130 is formed on the inorganic elastic undercoat layer 110.

The first intermediate coat layer 130 may include an acrylic emulsion elastic resin.

Thus, the first intermediate coat layer 130 may be environmentally friendly, and compatibility between the fiber reinforced sheet layers 140 may be excellent. In addition, a process in which the first intermediate coat layer 130 permeates and passes through the fiber reinforced sheet layer 140 and is bonded to the elastic undercoat layer 110 may be performed simultaneously during the first intermediate coat layer 130 work without a separate adhesion process, and a construction period may be shortened because there is no separate sheet attachment process.

The first intermediate coat layer may be made of 50% to 60% highly elastic acrylic emulsion resin, a white pigment with heat shielding properties, 5% to 20% nanosized or larger silicate hollow pigment, and 5% to 10% extender pigment for improving wear properties, strength, and hardness. The highly elastic acrylic emulsion resin is a material that has excellent strength and hardness and has reinforced water resistance, tensile strength, and adhesive strength through the formation of a coating film through fusion between emulsion particles after drying in a wet state and the formation of crosslinks through a reaction between particles.

The second intermediate coat layer 160 may be made of the same material as the first intermediate coat layer 130, may have excellent waterproofing performance, durability, elasticity, tensile strength, or the like, and may be applied to form a waterproof layer in a multi-layer structure.

The fiber reinforced sheet layer 140 may be made of PA net fibers and may include a long fiber nonwoven fabric sheet composed of a fiber layer.

In the fiber reinforced sheet layer 140, the fiber layer may include long fibers and may include at least one of aramid fibers, carbon fibers, basalt fibers, polyester fibers, cotton fibers, nylon fibers, acrylic fibers, polyurethane fibers, steel fibers, and glass fibers.

In this case, the fiber reinforced sheet layer 140 may have a width of 100 mm to 2,000 mm, a thickness of 35 mm to 2.0 mm, and a mass of 35 g/m² to 300 g/m². When an impact such as an earthquake or the like is applied to a structure to which a waterproof structure is applied, the occurrence of cracks may be suppressed by the fiber reinforced sheet layer 140, thereby obtaining an effect of preventing the sudden collapse of the structure.

Among the first and second impregnated layers 150, the first impregnated layer 150 may be made of the same material as the intermediate coat layer 130, may be mixed with about 30% water to increase the penetration and fixation inside a fiber sheet, and may include a non-slip agent when non-slip work is required. After the first impregnated layer is applied and dried, the second impregnated layer is diluted with a small amount of water to stably fix a fiber sheet layer in the multi-layer structure of thick coating feel and waterproofing after coating.

The second and third intermediate coat layers 160 may be made of the same material as the first intermediate coat layer 130 and may be used by mixing with silica sand when non-slip work is required. In addition, when heat shielding performance and insulation performance are required, heat insulation pigments may be added. When the second and third intermediate coat layers 160 are applied, an intermediate coating material is diluted with a minimum amount of water to form a waterproof multi-layer structure in terms of a thick coating feel and uniform coating characteristics.

The top coat layer 170 is formed on the second and third intermediate coat layers 160.

The top coat layer 170 may include an acrylic emulsion synthetic resin, may be made of a self-elastic acrylic material with excellent weatherability, may be resistant to external temperature changes, impacts, and moisture, may have excellent adhesion to the intermediate coat layer, and may also have heat shielding properties.

The top coat layer 170 may be formed by being applied on the second and third intermediate coat layers 160 and may function as a top coating layer.

The top coat layer 170 may be a composition that prevents yellowing while implementing a heat barrier effect, may be made of a non-yellowing acrylic emulsion resin, may include a heat blocker to have weatherability and be unlikely to be discolored, and may be formed by being applied using a working tool such as a roller, a lacquer, or a sprayer. In this case, the top coat layer 170 may include a first or second high-fineness powder to improve slip resistance, air permeability, antibacterial properties, and the like.

The top coat layer 170 may be formed by mixing 50 to 60 parts by weight of a water-soluble acrylic emulsion, 5 to 30 parts by weight of a heat blocker, and 5 to 10 parts by weight of an extender pigment and water with respect to a total of 100 parts by weight.

As a material of the top coat layer 170, various materials may be used. For example, the top coat layer 170 may be formed by mixing a coating film-forming agent for forming a coating film, a heat shielding pigment, a dispersing agent for preventing precipitation during dispersion and storage of an extender pigment, a thickener, and a pigment capable of exhibiting heat shielding and insulation properties.

A heat blocker included in the top coat layer 170 may be made of a pure one-component crosslinked resin that includes an acrylic resin and an insulation powder and does not include a curing agent.

Specifically, the acrylic resin may be a base material that forms a coating film and is included in the largest amount, and the insulation powder may include a hydrophilic powder, for example, silicon oxide (SiO₂), a fluorine component, or the like. As a result, it is possible to provide excellent insulation effects, excellent adhesion stability, or the like.

In addition, the top coat layer 170 may further include pigments that produce various colors, fibers that enhance strength, ultraviolet absorbers, and non-slip agents. For example, TiO₂ may be used as a pigment, and water or the like be used as a solvent. In the present invention, other than an acrylic resin, constituent materials such as silicon and fluorine and compositions may be modified in various ways.

FIG. 2 is an exemplary view for describing the application of a reinforcing sheet layer or an elastic sheet layer according to an embodiment of the present invention.

Referring to FIG. 2, the composite waterproof structure according to one embodiment of the present invention may further include an elastic or reinforcing sheet layer 180.

The elastic or reinforcing sheet layer 180 may be disposed on a connection portion of the adjacent fiber reinforced sheet layer 140, or may be disposed at a corner where the construction surface 1 meets a floor and wall.

The elastic or reinforcing sheet layer 180 may be made of an elastic PA sheet, and by adding elastic properties, the elastic or reinforcing sheet layer 180 may cope well with contraction and expansion caused by impacts from a building structure and an external environment, thereby improving crack resistance.

The above detailed description illustrates the present invention. The addition, the foregoing is intended to illustrate and describe the exemplary embodiments of the invention and the present invention may be utilized in various other combinations, modifications, and environments. That is, it is possible to make changes or modifications within the scope of the concept of the invention disclosed herein, within the scope equivalent to the above described disclosure, and/or within the skill and knowledge of the art. The above-described embodiments are intended to describe the best mode for carrying out the technical spirit of the present invention and various modifications required in the specific applications and uses of the present invention are possible. Accordingly, the detailed description of the invention above is not intended to limit the invention to the disclosed embodiments. In addition, the appended claims should be construed to include other embodiments.

1. A composite waterproof structure comprising:
an inorganic elastic undercoat layer which includes an inorganic material and is disposed on a construction surface;
a mesh-type fiber or chopped fiber reinforced layer attached to the elastic undercoat layer;
a first intermediate coat layer disposed on the fiber reinforced layer;
a fiber reinforced sheet layer attached to the first intermediate coat layer;
a first impregnated layer and a second impregnated layer disposed on the fiber reinforced sheet layer;
a second intermediate coat layer and a third intermediate coat layer disposed on the first and second impregnated layers; and
a first top coat layer disposed on the second and third intermediate coat layers.

2. The composite waterproof structure of claim 1, wherein the elastic undercoat layer includes 1 wt % to 10 wt % calcium sulfoaluminate (3Ca·3Al₂O₃·CaSO₄), which has a high fineness of 6,000 cm²/g to 12,000 cm²/g, 1 wt % to 10 wt % anhydrous gypsum, 20 wt % to 50 wt % of an inorganic binder in the form of an ultrafine powder, which is obtained by pulverizing portland cement type I to a fineness of 6,000 cm²/g to 9,000 cm²/g to have an average particle diameter of 4 μm, 5% to 10% of 325 mesh metakaolin, 40 wt % to 60 wt % of 0.5 mm to 2 mm silica sand, 5% to 10% silica fume, 1 wt % to 10 wt % ethylenevinyl acetate (EVA) powder resin, 0.1 wt % to 5 wt % of 6 mm aramid fiber or nylon fiber with respect to 100 parts by weight, 0.1% to 5% of 40 μm to 50 μm cellulose fiber, 0.1 to 1 part by weight of a powdered silicone foaming agent including 0.1 to 2.0 parts by weight of an accelerator and 0.01 to 1 part by weight of a setting retarder, wherein the accelerator includes at least one or a mixture of one or more selected from sodium sulfide (Na₂S·9H₂O), sodium carbonate (Na₂Co₃), lithium carbonate (Li₂Co₃), and lithium hydroxide (LiOH·H₂O), and the setting retarder includes at least one or a mixture of one or more selected from citric acid, tartaric acid, gluconic acid, boric acid, and potassium carbonate, 1% to 5% of at least one anti-freezing and moisture-retaining agent selected from the group consisting of 10% to 30% aqueous acrylic emulsion resin with a glass temperature (Tg) of −35° C., 1% to 10% silicone resin, ethylene glycol, and propylene glycol, and 0.1% to 3% dispersant.

3. The composite waterproof structure of claim 2, wherein the elastic undercoat layer further includes a reinforcing mesh fiber or a chop fiber reinforced layer.

4. The composite waterproof structure of claim 1, further comprising an elastic sheet layer disposed on a connection portion of the fiber reinforced sheet layer adjacent thereto.

5. The composite waterproof structure of claim 4, wherein the first intermediate coat layer is disposed on the fiber reinforced sheet layer and the elastic sheet layer.

6. The composite waterproof structure of claim 1, wherein the first intermediate coat layer includes an acrylic emulsion resin.
